(19) United States
(12) Patent Application Publication
(10) Pub. No.: US 2002/0082025 A1
(43) Pub. Date: Jun. 27, 2002

(54) Method and device for locating a vehicle

(76) Inventors: Gero Baese, Muenchen (DE); Martin Gebler, Pulach im Isartal (DE); Sabine Markgraf, Gauting (DE); Annette Schlossnikel, Muenchen (DE); Thomas Strobel, Gauting (DE); Juergen Wilde, Taufkirchen (DE); Andre Fischer, Berlin (DE); Peter Moritz, Haar (DE); Stefan Prange, Muenchen (DE); Arnd Sibila, Moorenweis (DE); Christian Von Brockdorff, Icking (DE)

Correspondence Address: BELL, BOYD & LLOYD, LLC, P. O. BOX 1135, CHICAGO, IL, 60690-1135, US

(21) Appl. No.: 09/964,092

(22) Filed: Sep. 26, 2001

(30) Foreign Application Priority Data
Sep. 26, 2000 (DE) 10047605.8
Oct. 17, 2000 (DE) 10051406.5

(51) Int. Cl. H04Q 7/20

(52) U.S. Cl. 455/456; 455/457; 455/517

(57) ABSTRACT

A method and device for locating a vehicle is provided. The method of locating a vehicle is made possible according to the invention by means of a vehicle-end position-determining device for determining position data which are transferred to a mobile radio terminal in order to display route instructions to the vehicle.

### BACKGROUND OF THE INVENTION

The invention relates to a method and a device for locating a vehicle. In many instances it is necessary for a vehicle owner to locate his or her vehicle within a crowded parking lot, or within a multi-story parking garage. In such cases, it is desirable that the vehicle owner is provided with a mechanism for locating his or her vehicle. The object of the present invention is to make it possible for the vehicle owner to locate a vehicle easily and efficiently using mobile radio terminal.

### SUMMARY OF THE INVENTION

The present invention provides a method for locating a vehicle as well as a device for doing the same and a position information server for use in a vehicle location system. According to the method of the present invention, vehicle position data are determined at the vehicle using a position determining device. The position data are then transferred to a mobile radio terminal where these may be displayed.

Further, where necessary, the position data may be transferred from the mobile radio terminal to a center in order to generate specific route instructions to the vehicle. The data transfer from the vehicle to a mobile radio terminal can be carried out, in particular, by mobile radio (for example GPRS, SMS, USSD etc.), bluetooth or via a cable interface at the mobile radio terminal. The transmission of position data from the mobile radio terminal to the service center and the transfer back of route instructions can be carried out, for example, by mobile radio or bluetooth. The determining of position data in the vehicle is preferably carried out by means of a satellite navigation system such as a global positioning system (GPS) or by means of distance sensors (odometers) and direction-of-travel sensors (in particular an electronic compass).

The device for determining the location of a vehicle includes a vehicle mounted positioning device, and a transmitter for transmitting position data representing the location of the vehicle generated by the positioning device to the mobile radio terminal. The position information server includes a receiver for receiving position data transmitted other from the car; or from the mobile radio terminal. The server also includes a transmitter for transmitting position data as well as map data back to the mobile radio terminal or the vehicle.

Further features and advantages of the invention emerge from the following description of an exemplary embodiment with reference to the drawing, in which:

### BRIEF DESCRIPTION OF THE FIGURES

FIG. 1 is a block diagram of a system according to the invention,

FIG. 2 is a flowchart of the sequence of steps performed during the course of locating a vehicle according to the method of the present invention.

### DETAILED DESCRIPTION OF THE INVENTION

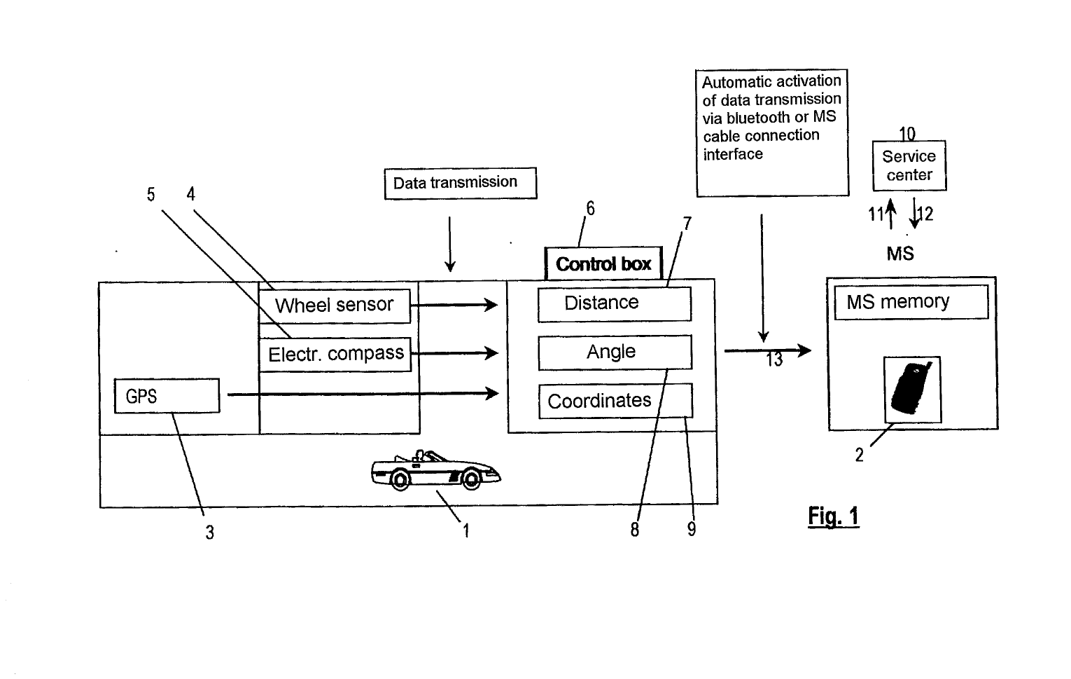

FIG. 1 shows a vehicle 1 which is to be located according to the present invention. The location of the vehicle is to be provided to the vehicle owner via a mobile radio terminal 2. If satellite reception is possible, vehicle position data can be generated at the vehicle by means of a satellite navigation system or global positioning system (GPS) 3. Alternatively, or in addition to GPS position data, the vehicle position may be determined by means of vehicle-end autonomous locating systems, such as, for example by means of a wheel sensor 4 which measures distances traveled by means of rotations of the wheels (corresponding to an odometer), and by means of a direction sensor, for example, an electric compass 5 (or for example by measuring clocking of the steering wheel). The two-dimensional or three-dimensional position of a vehicle may be determined from this raw data by a computing device 6 (in the vehicle or a server which receives position data from the vehicle). Distance data 7 determined by wheel sensors 4, angle data determined by an electric compass, etc., and coordinate data 9 determined by a satellite navigation system 3 can all be used for this purpose. Moreover, data from digital maps of roads, towns, multistory parking garages, and the like, which may be present in the computing device 6, can be used to superimpose (map matching) position data 7, 8, 9 on possible locations of the vehicle, thus allowing position-determining precision to be optimized.

The position data can be determined uni-dimensionally (for example as direction information), two-dimensionally (as information relating to direction and distance) or three-dimensionally (as information relating to direction and distance and story/level). Three-dimensional determining of data may be appropriate, for example, in a multistory car park with a plurality of levels. Three-dimensional determining of position data may be carried out by means of a precise satellite navigation system or, for example, by means of an inclination sensor with an evaluation device which can determine positive and negative gradients (and resulting stories) which the vehicle traveled on in a multistory car park etc.

Data based on the position data 7, 8, 9 determined by the computing device 6 (in the vehicle 1 or in a service center which is not shown) are transferred to a mobile radio terminal 2. This can be carried out, for example, by means of a bluetooth transmission or a mobile radio transmission or by a line-bound interface of the mobile radio terminal 2. The data transferred to the mobile radio terminal 2 can contain, for example, the absolute position or relative position (relating to the mobile radio terminal 2) of the vehicle 1. The position of the vehicle relative to the mobile radio may be displayed, for example, as an arrow on the display of the mobile radio terminal. Alternatively, or in addition, additional directional instructions (direction, story information etc.) may also be displayed.

In screened regions (e.g., regions in which there is no mobile radio reception, GPS reception, etc.) it is possible to generate indoor position data, the position data of the vehicle within the screened structure, using permanently installed beacons, such as, for example, bluetooth transmitter/receiver devices. In this way, the position of the motor vehicle can be determined, even within screened regions, both at the motor vehicle end during the determination of its position and at a mobile radio terminal when the owner of the vehicle is searching for the motor vehicle.

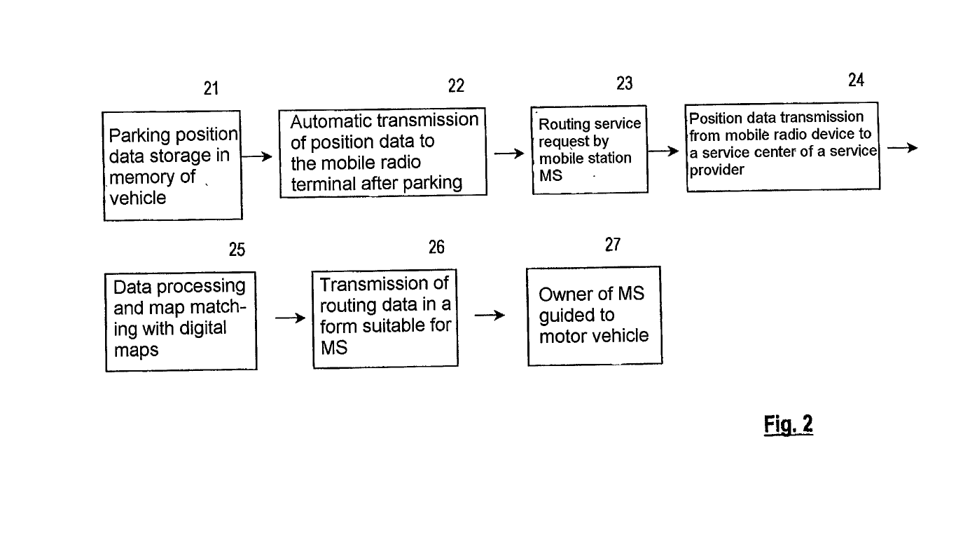

FIG. 2 shows a flowchart of an exemplary embodiment of the method of the present invention. In step 21, parking position data of a parked vehicle is stored in the vehicle. The vehicle position data which represent the current position of the parked vehicle are determined in accordance with one of the alternatives specified above. In step 22, the parking position data are transferred automatically from a vehicle-end transmitter device (for example a mobile radio mounted on the vehicle) directly to a predefined mobile radio terminal (for example the mobile radio terminal of the owner of the vehicle having a predefined telephone number which is stored at the vehicle end). If the vehicle owner activates a search function on his mobile radio terminal 2 for searching for his or her vehicle 1, for example, by pressing certain keys on the mobile radio terminal, or by voice input or some other input mechanism, a location-determining service is activated at step 23. For this purpose, in step 24, the parking position data are transferred from the mobile radio terminal 2 to a service provider 10. The service provider 10 is contacted through a service center operated by the service provider, wherein contact information regarding the service center such as the telephone number, address, and the like are stored in the mobile radio terminal 2. In step 25, the position data 7-9 (see FIG. 1), which have been transferred from the mobile radio terminal 2 to a service provider is superimposed on data present at the service center. The data at the service center may include data such as road maps, town maps, building plans (of multistory parking garages etc.) so that the vehicle may be located within the context of a specific map. For example, the position of the vehicle may be displayed in a particular parking spot on a street, or a parking space within a multistory parking garage, and so forth. Data from the vehicle position data and the map data stored at the service center are calculated and transmitted back to the terminal 2. This data may comprise one or more specific directional instructions such as, for example, “turn left at next crossroads,” “first door on right,” etc., which are displayed or audibly delivered at the mobile radio terminal 2. Alternatively, data transmitted back to the mobile radio terminal may comprise locational data to be further processed at the terminal 2. The data which are based on the position data 7-9 and are generated by the service center (route instructions, position information etc.) are transferred in a suitable form (text, graphics, speech in the form of short messages USSD, WML, XML etc.) from the service center 10 to the mobile radio terminal 2 (by mobile radio or by bluetooth, etc.) so that route instructions may be displayed. Suitable data are issued to the user of the terminal 2 by means of the mobile radio terminal in visual/audible form. For example, the instructions may be delivered audibly via mobile radio terminal's loudspeaker or may be displayed visually on an LCD or the like. The data include, for example, direction (by means of an arrow on the display of the terminal 2 etc.), distance (on the display), directional instructions (next door right, two stories up and then to left), and the like.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A method for locating a vehicle comprising the steps of:
determining vehicle position data using a position-determining device at the vehicle; and
transferring the vehicle position data to a mobile radio terminal.

2. The method of claim 1, wherein the step of determining vehicle position data is performed by a satellite navigation system.

3. The method of claim 1, wherein the step of determining vehicle position data is performed by distance sensors and direction of travel sensors.

4. The method of claim 1 further comprising the step of transferring the vehicle position data determined at the vehicle to a service center.

5. The method of claim 4, further comprising the steps of transferring data based on the position data from the mobile radio terminal to a service center, generating data base on the position data at the service center, and transferring the generated data back to the mobile radio terminal.

6. The method of claim 5, wherein said vehicle position data are transferred to a service center via one of a mobile radio or bluetooth.

7. The method of claim 6, further comprising the steps of transferring data based on the position data from the mobile radio terminal to a service center, generating data base on the position data at the service center, and transferring the generated data back to the mobile radio terminal.

8. The method of claim 4, wherein said vehicle position data are transferred to a service center via one of a mobile radio or bluetooth.

9. The method of claim 1, further comprising the steps of transferring data based on the position data from the mobile radio terminal to a service center, generating data based on the position data at the service center, and transferring the generated data back to the mobile radio terminal.

10. The method of claim 9, further including the step of superimposing data comprising electronic map data of the position data generated at the service center.

11. The method of claim 10, wherein the data comprising said electronic map data comprises one of a map of a multi-story parking garage, a parking lot, or a town.

12. The method of claim 9, wherein the data transferred back to the mobile radio terminal comprises at least one of directional information, distance information and turning instructions.

13. A device for determining the position of a vehicle comprising:
means for determining the position of the vehicle mounted on the vehicle; and
a transmitter device for transmitting position data representing the position of the vehicle generated by the position determining means to a mobile radio terminal.

14. A position information server for use in a vehicle location system wherein vehicle position data generated on the vehicle is transmitted to a mobile radio terminal, said position information server comprising:
a receiver device for receiving position data transmitted by one of a vehicle or a mobile radio terminal, and
a transmitter device for transmitting data based on the position data to the mobile radio terminal.

15. The position information server as claimed in claim 11, wherein the receiver device and/or the transmitter device are bluetooth-based.

16. The position information server as claimed in claim 11, wherein the receiver device and/or the transmitter device of the position information server are mobile-radio-based.
